(19) United States
(12) Patent Application Publication
(10) Pub. No.: US 2018/0173776 A1
(43) Pub. Date: Jun. 21, 2018

(54) Mapping 1:Many Relationships for Elements in a Database System

(71) Applicant: SAP SE, Walldorf (DE)

(72) Inventor: David Hock, Poway, CA (US)

(21) Appl. No.: 15/386,969

(22) Filed: Dec. 21, 2016

(51) Int. Cl. G06F 17/30

(52) U.S. Cl. CPC G06F 17/30569; G06F 17/30604

(57) ABSTRACT

In one embodiment, a mapping of a source element from source data to a destination element in the view is detected. The method analyzes a first path of the source element and a second path for a parent element to the destination element to determine whether the mapping should use an absolute path or a relative path. When the relative path should be used, the relative path is stored to map the destination element to the source element. When the absolute path should be used, the absolute path is stored to map the destination field to the source element. Then, the method generates a document that maps the source element in the source format to destination data in the destination format, the source element being retrieved from the source data using the relative path or the absolute path.

### BACKGROUND

A first company may have a proprietary internal format in which the first company stores source data. The first company may then need to produce destination data for a second company. However, the second company may have its own destination format that is different from the internal format. The first company then needs to map the source data from the internal format to the destination format. The process for setting up the mapping may be a highly manual process and require a large number of user hours. Also, it may be hard to map certain types of elements from the source format to the destination format correctly.

### BRIEF DESCRIPTION OF THE DRAWINGS

FIG. 1 depicts a simplified system of a method for mapping source data to destination data according to one embodiment.

FIG. 2 depicts a simplified flowchart of a method for pre-processing the destination format to generate the destination view according to one embodiment.

FIG. 3 shows an example of a user interface according to one embodiment.

FIG. 4 depicts a simplified flowchart of a method for processing a mapping according to one embodiment.

FIG. 5 depicts a simplified flowchart of a method for generating destination data in the destination format according to one embodiment.

FIG. 6 shows a more detailed example of a preview view that includes a portion of the destination data according to one embodiment.

FIG. 7 illustrates hardware of a special purpose computing machine configured with the mapping tool according to one embodiment.

### DETAILED DESCRIPTION

Described herein are techniques for a data mapping system. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

Particular embodiments provide a mapping tool to map between a source format for source data to a destination format for destination data. The mapping tool generates a destination view of a destination format in a user interface. The destination view may specify a hierarchy of destination elements in the destination format. In one embodiment, the hierarchy includes destination elements including identifiers arranged in the hierarchy. These destination elements need to be mapped to source elements from the source data that are shown in a source view in the user interface.

In one embodiment, mappings are received from a user that specify mappings between source elements in the source view and the destination elements in the destination view. The mapping tool then analyzes a first path for the source element and a second path for a parent element of the destination element to determine whether the mapping of the destination element to the source element should use an absolute path or a relative path. When the relative path should be used, the mapping tool stores a mapping for the destination element to the source element with a relative path. The relative path is a path that is dependent upon the second path for the parent element for the destination element to retrieve the source element. When the absolute path should be used, the mapping tool stores a mapping for the destination element to the source element with an absolute path. The absolute path is not dependent on the second path for the parent element and the first path alone can be used to retrieve the source element. Then, after the mappings have been received, the mapping tool generates a document that maps the source data in the source format to destination data in the destination format. The relative path or the absolute path is used to retrieve the source elements to generate the destination data.

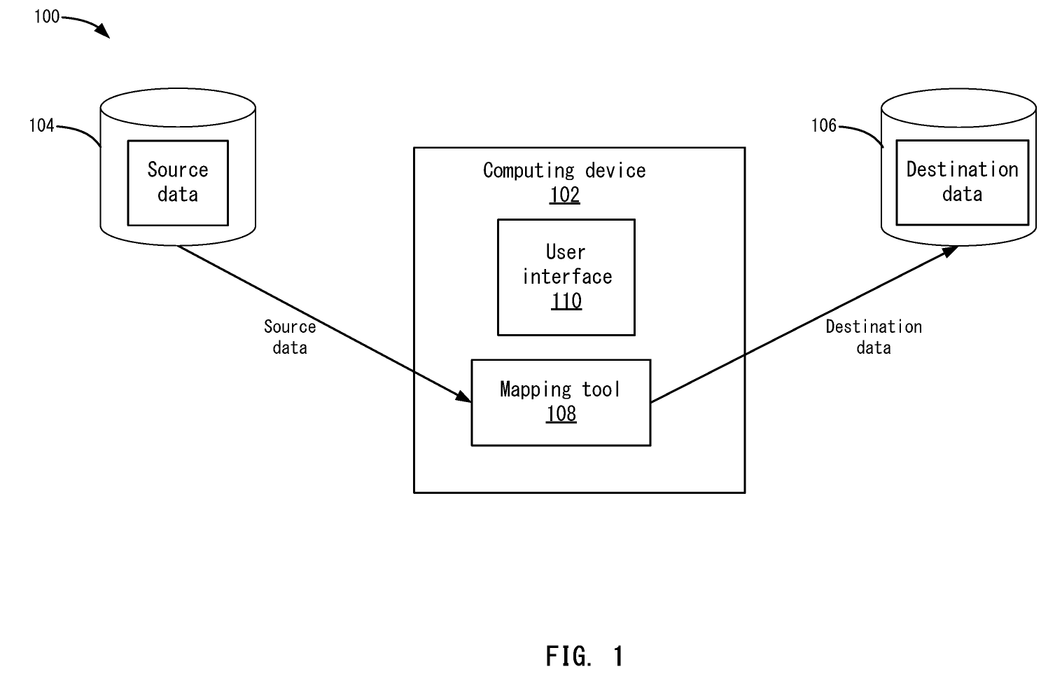

FIG. 1 depicts a simplified system 100 for mapping source data to destination data according to one embodiment. System 100 includes a computing device 102, first storage 104 for storing source data, and second storage 106 for storing destination data. Computing device 102 also includes a mapping tool 108 and a user interface 110.

The source data may be in a source format and the destination data may be in a destination format. In one example, a user desires to take the source data in the source format and output destination data in the destination format. In one embodiment, the source format is stored in a first hierarchical format and the destination format is stored in a second hierarchical format. The source format includes source elements and the destination format includes destination elements that may have different identifiers from the source elements.

Mapping tool 108 is configured to perform a mapping between source elements and destination elements via user interface 110. For example, mapping tool 108 may generate a user interface 110 in which input from a user can be used to define the mapping.

User interface 110 may include a source view that describes the source format, a destination view that describes the destination format, and a preview view that previews the destination data based on the mapping between the source format and the destination format. Mapping tool 108 may generate a destination view for the destination format that describes a hierarchy of destination elements in the destination format. Then, a user may use a source view of source elements in the source format to specify which source elements should be mapped to destination elements in the destination view. As will described in more detail below, user interface 110 allows relative addressing to be set up by first receiving an input specifying a source parent to a destination parent and then receiving an input specifying source child fields below the corresponding destination parent.

When mappings are received, mapping tool 108 generates a mapping from the source element to the destination element. As will be described in more detail below, the source format may have repeating source elements representing 1:many relationships. The source elements are first mapped to a destination element, which also has child destination elements (e.g., fields). Then, other source elements are mapped as child source elements for the child destination elements. Mapping tool 108 may configure the paths for child source elements of the 1:many source elements when a user specifies a child source element is mapped to a child destination element. For example, mapping tool 108 may determine whether an absolute path or a relative path should be stored for the mapping. The absolute path is a full path to the source element in the source data. That is, only the absolute path is needed to retrieve source data for the source element in first storage 104. For example, the source element may be part of a group (e.g., directory) of the parent element. The relative path would reference a path to the group. The relative path is a path that is dependent upon a parent element for the destination element. That is, the relative path is dependent on part of the path for the parent element to retrieve the source data for the child source element in first storage 104. The use of relative paths for 1:many elements allows the child source elements in the 1:many relationship to be included in the destination data because iteration across the 1:many elements (e.g., an employee's different jobs) and reference individual fields for each job, such as start date. In the iteration, all the employees jobs with different start dates can be listed. The relative path would use the prefix of the parent and add a different portion at the end of the prefix for each job. One example, may be “/user1/job1” for a first relative path of a first job and “/user1/job2” for a second relative path of a second job. The iteration would use both paths to retrieve information for both jobs. If absolute paths were used, all of the elements could not be included because the absolute path would point to a single job with a single start date.

The process for performing the mapping includes a pre-processing step that generates the initial destination view of the destination elements. Then, in a mapping process, input from the user using user interface 110 may be received to map source elements to destination elements.

Pre-Processing

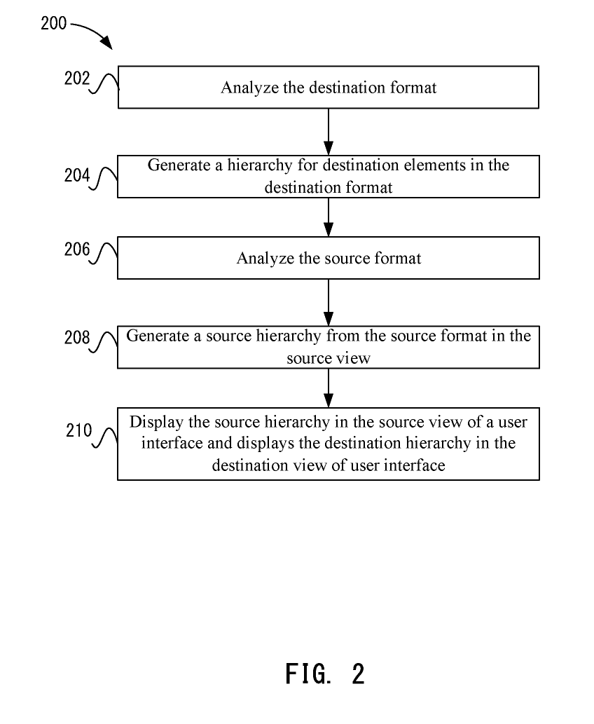

FIG. 2 depicts a simplified flowchart 200 of a method for pre-processing the destination format to generate the destination view according to one embodiment. At 202, mapping tool 108 analyzes the destination format. For example, mapping tool 108 may analyze an example of destination data in the destination format to detect the structure of the destination format and the destination elements included in the destination data. In another embodiment, the format may be received from a user or a file.

At 204, mapping tool 108 generates a hierarchy for destination elements in the destination format. For example, the hierarchy may lay out destination elements in a parent/child hierarchy in a tree format. The child element would be a descendant of the parent element or depend on the parent element. The destination elements include destination identifiers that are created from the destination identifiers in the destination data.

The source view also is created so mappings can be specified. At 206, mapping tool 108 analyzes the source format. For example, mapping tool 108 may analyze the source data in the source format to determine source elements.

At 208, mapping tool 108 generates a source hierarchy from the source format in the source view. The source hierarchy may specify source elements in a parent/child hierarchy that includes source identifiers created from the source data.

At 210, mapping tool 108 displays the source hierarchy in the source view of user interface 110 and displays the destination hierarchy in the destination view of user interface 110. This may display the source elements and destination elements with their respective identifiers. In one embodiment, the source identifiers and destination identifiers may be different and also the source hierarchy and the destination hierarchy may be different. Once the source format and the destination format are displayed in user interface 110, a user can map the source elements to destination elements using user interface 110.

Mapping

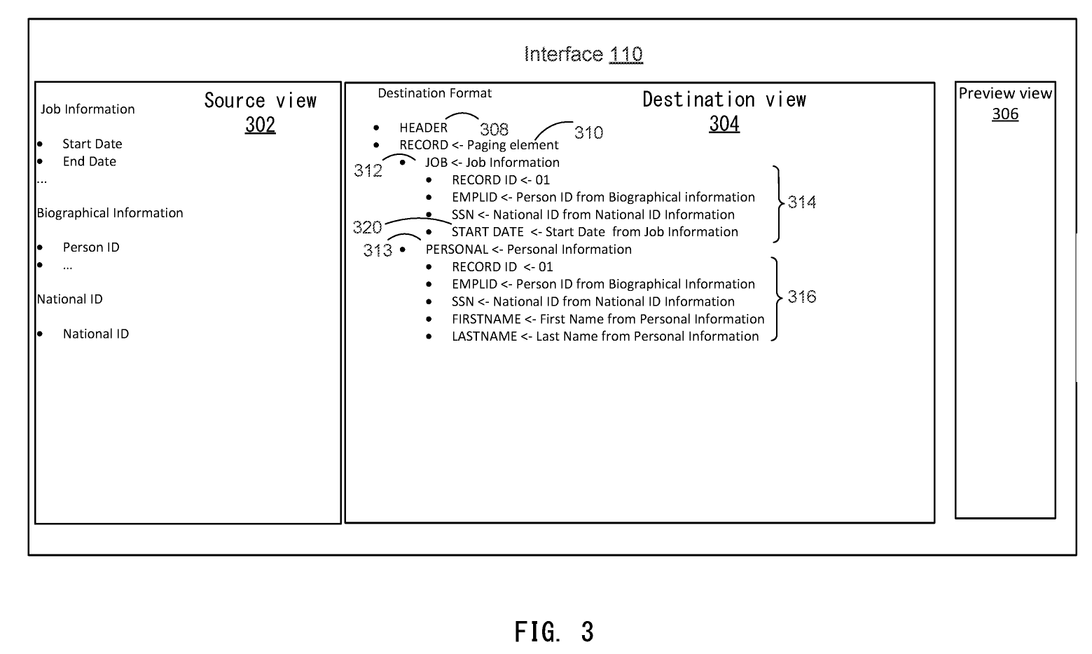

To generate destination data from the source data, mapping tool 108 maps source elements to destination elements. In one embodiment, mapping tool 108 may receive input specify mappings from a user using interface 110. In another embodiment, mapping tool 108 may automatically map source elements to destination elements. The mapping may specify which source elements are associated with destination elements. FIG. 3 shows an example of user interface 110 according to one embodiment. A source view 302 shows source elements for the source format. A destination view 304 shows destination elements for the destination format. A preview view 306 shows a preview of the destination data based on a current status of the mapping.

Destination elements in destination view 304 are arranged in a destination hierarchy. The destination hierarchy may include different types of destination elements. The destination elements are shown in capital letters and also after the “←” symbol, comments for the mapping to source elements are shown.

The destination elements may include different types of destination elements including single elements, paging elements, and 1:many elements. Single destination elements are elements that only appear once in the destination data. In this case, one single destination element is named “HEADER” at 308.

At 310, a paging destination element is shown that repeats for each source record. A paging element may also be referred to a batch element. The paging element at 310 is labeled “RECORD”. In this case, this element in the destination data may repeat for every employee in the company that is determined from the source data. A paging element may have a parent element that is a single element.

At 312, a 1:many destination element is shown of “JOB”. A 1:many element is a nested repeating element within the paging element. That is, the employee for a paging element may have multiple jobs in his/her job history and those multiple jobs may be listed in the destination data.

At 313, a single element of “PERSONAL” is shown. The PERSONAL element is personal information for the employee. An employee has only one record for personal information.

A user can specify source elements in source view 302 that are mapped to destination elements in destination view 304. For example, for all the destination elements listed in source view 302, mapping tool 108 needs to know where in first storage 104 to retrieve the source data. To specify the mappings, input from a user can specify which source elements correspond to which destination elements. Different ways of performing the specification may be used. In one example, a user may “drag and drop” source elements in source view 302 onto destination elements in destination view 304. The drag and drop is where the user selects a source element and moves the source element to a destination element. Other methods of specifying which source elements correspond to destination elements may also be used.

Mapping tool 108 may enforce some rules when mappings are received. For example, a source element can only be associated with destination elements that are descendants of the paging element. An input from a user cannot specify a mapping to the paging element or to siblings of the paging element. Source properties or source elements from first section 302 can be dropped to child elements in second section 304. A child element is an element that is a descendant of a parent element. Mapping tool 108 does not allow the dropping of source properties or source elements onto destination parent elements, such as paging element 310. Rather, mapping tool 108 allows source elements to be dropped on child elements of the parent elements. For example, the rules may not allow a mapping of a source parent (e.g., a customer order) to a destination child field (e.g., an order number). A parent represents an object and a child field represents a field within an object.

Mapping tool 108 allows source parent elements from first section 302 to be mapped to destination parent elements in second section 304. The properties of source parent elements specify a path to a directory of the source data. The properties may include a path that can be used as a prefix to retrieve child elements for the parent elements. Mapping tool 108 does not allow parent elements to be specified for child elements as discussed above.

At 314, destination elements for the destination format are listed for a parent element of JOB shown at 312. The destination elements have destination identifiers of RECORD_ID, EMPLID, SSN, AND START_DATE. At 316, destination elements for the destination format for a parent element of PERSONAL are shown. The destination elements have destination identifiers of RECORD_ID, EMPLID, SSN, FIRSTNAME, and LASTNAME. These destination identifiers are included in the destination data.

Input from a user is used to map source elements to these destination elements. This specifies where mapping tool 108 can retrieve source data that is needed to generate the destination data. The mappings for each destination element are shown after the “←” symbol. It is noted that these mappings may or may not be shown on interface 110. Each mapping shows the source identifier name that has been mapped to the respective destination element. For example, the destination element “RECORD_ID” may be mapped to the source element “−01”. In this notation, “01” is the source element identifier that is mapped to the destination element, and 01 is the storage name for the source element. For the destination element “EMPLID”, the source element of “Person ID from Biographical Information” is mapped to EMPLID. The notation “from Biographical Information” indicates what group the source element is from, such as Biographical Information is a parent element (e.g., directory) of EMPLID in the source data. Further, the destination element of “SSN” is mapped to “National ID from National ID information”, “FIRSTNAME” is mapped to “First Name from Personal Information, and “LASTNAME” is mapped to “Last Name from Personal Information”. Using this mapping, for each record in the source data, each employee would have a single instance of this personal information listed in the destination data. Mapping tool 108 uses absolute paths to map the destination elements to the source elements because PERSONAL is a 1:1 element in the source data.

The parent element in the destination view of “JOB” is mapped to a nested repeating element in the source data of “Job Information”. The mapping to the source element of “Job Information” is performed by receiving input from the user specifying a source element of “Job Information” as being mapped to the destination element of “JOB”. The “JOB” element is a 1:many element because it is dependent on a paging element and also mapped to a repeating element in the source data.

The “JOB” element is a parent element that has child elements (e.g., child elements) that are shown at 314 of “RECORD_ID”, “EMPLID”, “SSN” and “START_DATE”. The source elements of “01”, “Person ID from Biological Information”, and “National ID from National ID Information” have been mapped to the destination elements of “RECORD_ID”, “EMPLID”, and “SSN”, respectively. Mapping tool 108 uses absolute paths when source elements are mapped to the destination elements under “JOB” from outside the group (e.g., the source element Job Information) mapped to the “JOB” destination element. The source elements for these three destination elements are from outside of the JOB Information source element. Thus, mapping tool 108 uses absolute paths to the source elements. That is, there is only one instance of the record ID, employer ID and social security number.

Mapping tool 108 uses relative paths when source elements are mapped to the destination elements under “JOB” from within the group (e.g., the source element Job Information) mapped to the “JOB” destination element. For the destination element of START_DATE at 320, the source element is from the parent element of Job Information. Mapping tool 108 uses a relative path in this case because the source element references the parent Job Information. In this case, for every job an employee had, a new start date is used. However, the record ID, employer ID and SSN would be the same for each job which is why mapping tool 108 used absolute paths.

The “PERSONAL” destination element is a parent element that has child elements (e.g., child elements) that are shown at 316 of “RECORD_ID”, “EMPLID”, “SSN”, “FIRSTNAME”, and “LASTNAME”. The source elements of “01”, “Person ID from Biological Information”, and “National ID from National ID Information”, “First Name from Personal Information”, and “Last Name from Personal Information” have been mapped to the destination elements of “RECORD_ID”, “EMPLID”, “SSN”, “FIRSTNAME”, and “LASTNAME”, respectively. The PERSONAL destination element is a 1:1 element because the element is mapped to a single element of Personal Information in the source data and mapping tool 108 uses absolute paths for all the child elements. This includes both instances when source elements are mapped to the destination elements under “PERSONAL” from outside the group (e.g., the source element Personal Information) and from within the Personal Information group. This is because there is only one instance of the Record ID, employer ID, SSN, First Name and Last name in the source data. It is noted that a relative path for First Name and Last Name could be used since these source elements fall within the same group (e.g., Personal Information) as the source element of PERSONAL. The process of determining whether to use an absolute path or relative path will now be described.

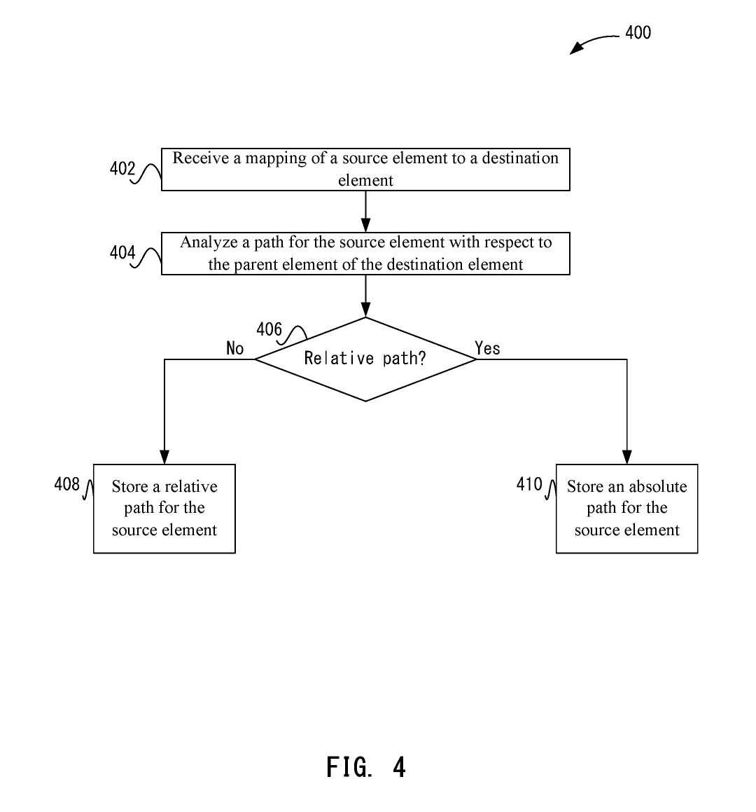

FIG. 4 depicts a simplified flowchart 400 of a method for processing a mapping according to one embodiment. At 402, mapping tool 108 receives a mapping of a source element to a destination element. For example, a user may drag and drop a source element from source view 302 to a destination element in destination view 304 on interface 110.

At 404, mapping tool 108 analyzes a path for the source element with respect to the parent element of the destination element. For example, the source element may have an absolute path in the source data. Also, a parent element of the destination element may be associated with a parent source element that has an absolute path in the source data. For example, the parent element of the destination element may be associated with the User source element shown at 312 and a user ID source element may also have an absolute path. Mapping tool 108 may compare a first absolute path for the source element and a second absolute path for the parent source element to determine whether the first absolute path and the second absolute path include a prefix that matches. For example, mapping tool 108 is determining whether or not the source element that has been mapped is from within the same group as the parent element. If the source element is within the parent source element's group, then the first absolute path and the second absolute path will include the same prefix. If the source element is not from within the parent source element's group, then the first path and the second path would not have the same prefix.

At 406, based on the analysis, mapping tool 108 determines if a relative path should be used. At 408, if a relative path should be used, then mapping tool 108 stores a relative path for the source element. At 410, if a relative path should not be used, mapping tool 108 stores an absolute path for the source element.

Destination Data Generation

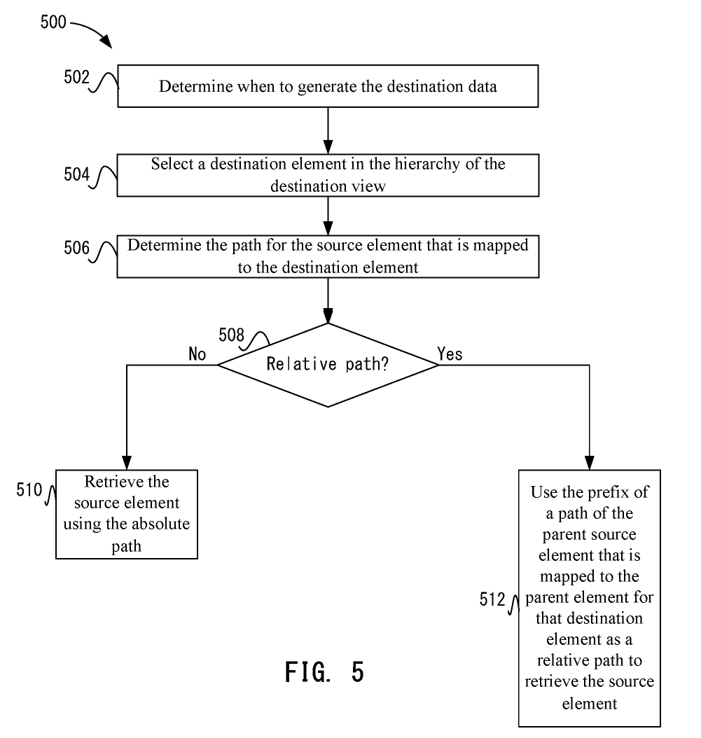

Once the mapping is finished or in real-time as mappings are generated, mapping tool 108 generates destination data. FIG. 5 depicts a simplified flowchart 500 of a method for generating destination data in the destination format according to one embodiment. At 502, mapping tool 108 determines when to generate the destination data. For example, a user may input a request to generate the destination data for upload to another company. In another example, mapping tool 108 may generate the destination data in the preview section 306 of user interface 110 dynamically as input from a user maps source elements for destination elements.

At 504, mapping tool 108 selects a destination element in the hierarchy of the destination view. At 506, mapping tool 108 determines the path for the source element that is mapped to the destination element. At 508, mapping tool 108 determines whether the path is an absolute path or a relative path. At 510, if the path is an absolute path, mapping tool 108 retrieves the source element using the absolute path. At 512, if the path is a relative path, mapping tool 108 uses the prefix of a path of the parent source element that is mapped to the parent element for that destination element as a relative path to retrieve the source element. At 514, mapping tool 108 then stores the retrieved source element in the destination data in the destination format.

At 516, mapping tool 108 determines if there is another source element for the destination element to process. For example, a 1:many element may need to retrieve another source element. In one example, a user may have multiple direct reports that need to be processed. If there is another element, the process reiterates to 506 to determine another source element. If there are no only elements, the process ends.

The use of the relative path allows multiple source elements to be included in the destination data for a destination element that is a 1:many relationship. Relative paths allow mapping tool 108 to iterate across the 1:many elements (e.g., each job for an employee) and reference individual fields for each job like start date. That way all the jobs for an employee can be listed.

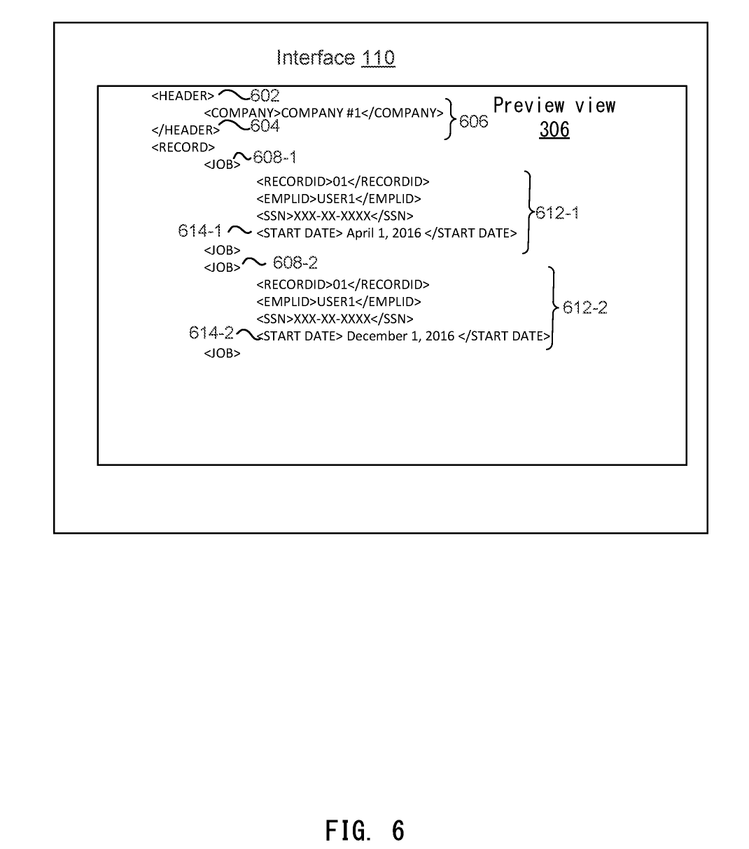

FIG. 6 shows a more detailed example of a preview view 306 that includes a portion of the destination data according to one embodiment. At 602, the destination element of “HEADER” is shown. This is a single elements and does not have any source elements mapped to it. At 606, source data for the destination elements has been retrieved for the HEADER destination element.

At 604, the paging element at 310 is shown. This is a paging element and thus may appear multiple times for each record found in the source data.

Then, for the JOB destination element from a destination element 312, the employee includes a Job #1 at 608-1 and a Job #2 at 608-2. This is a 1:many relationship where the employee includes multiple jobs. Each job may include a number of destination elements shown at 612-1 and 612-2, respectively. The information for the RECORDID, EMPLID, AND SSN for the employee is shown. The information is the same for each job because an absolute path retrieves the same information. However, the START_DATE element uses a relative path and the information is different for each iteration of the jobs. For example, at 614-1, the start date is Apr. 1, 2016 for Job #1 and at 614-2, the start date is Dec. 1, 2016 for Job #2. Accordingly, particular embodiments provide a mapping tool that can allow a user to specify source elements for destination elements. The mapping tool can automatically determine whether or not an absolute path or a relative path is used. Conventionally, when a 1:many relationship is used for a destination element, only one source element could be specified. However, using a relative path, multiple source elements can be specified in the mapping.

System

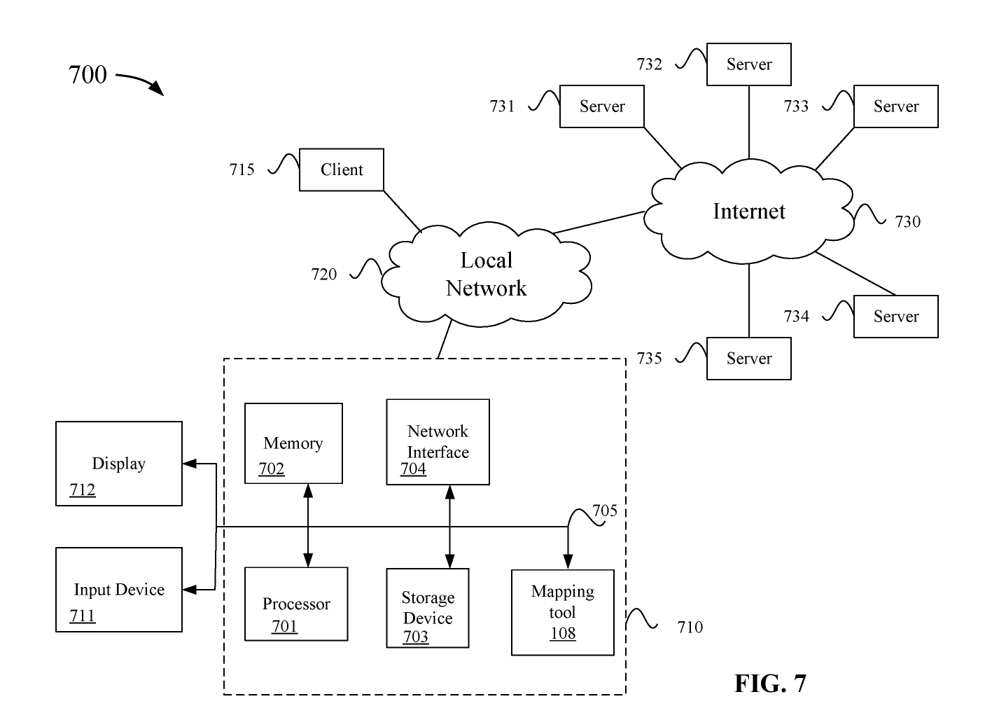

FIG. 7 illustrates hardware of a special purpose computing machine configured with mapping tool 108 according to one embodiment. An example computer system 710 is illustrated in FIG. 7. Computer system 710 includes a bus 705 or other communication mechanism for communicating information, and a processor 701 coupled with bus 705 for processing information. Computer system 710 also includes a memory 702 coupled to bus 705 for storing information and instructions to be executed by processor 701, including information and instructions for performing the techniques described above, for example. This memory may also be used for storing variables or other intermediate information during execution of instructions to be executed by processor 701. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 703 may include source code, binary code, or software files for performing the techniques above, for example. Storage device and memory are both examples of computer readable storage mediums.

Computer system 710 may be coupled via bus 705 to a display 712, such as a cathode ray tube (CRT) or liquid crystal display (LCD), for displaying information to a computer user. An input device 711 such as a keyboard and/or mouse is coupled to bus 705 for communicating information and command selections from the user to processor 701. The combination of these components allows the user to communicate with the system. In some systems, bus 705 may be divided into multiple specialized buses.

Computer system 710 also includes a network interface 704 coupled with bus 705. Network interface 704 may provide two-way data communication between computer system 710 and the local network 720. The network interface 704 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 704 sends and receives electrical, electromagnetic, or optical signals that carry digital data streams representing various types of information.

Computer system 710 can send and receive information through the network interface 704 across a local network 720, an Intranet, or the Internet 730. In the Internet example, software components or services may reside on multiple different computer systems 710 or servers 731-735 across the network. The processes described above may be implemented on one or more servers, for example. A server 731 may transmit actions or messages from one component, through Internet 730, local network 720, and network interface 704 to a component on computer system 710. The software components and processes described above may be implemented on any computer system and send and/or receive information across a network, for example.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be configured to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
generating, by a computing device, a view of destination elements that are in a destination format;
detecting, by the computing device, a mapping of a source element from source data to a destination element in the view;
analyzing, by the computing device, a first path of the source element and a second path for a parent element to the destination element to determine whether the mapping should use an absolute path or a relative path;
when the relative path should be used, storing, by the computing device, the relative path to map the destination element to the source element, the relative path being dependent on the second path for the parent element;
when the absolute path should be used, storing, by the computing device, the absolute path to map the destination field to the source element, the absolute path not being dependent on the second path for the parent element; and
generating, by the computing device, a document that maps the source element in the source format to destination data in the destination format, the source element being retrieved from the source data using the relative path or the absolute path.

2. The method of claim 1, wherein analyzing comprises:
determining, by the computing device, when a prefix of the first path of the source element matches at least a portion of the second path of the parent element;
when the prefix matches the at least a portion of the second path, determining the relative path should be used; and
when the prefix does not match the at least a portion of the second path does not match, determining the absolute path should be used.

3. The method of claim 1, wherein the parent element is a 1:many element indicating the parent element repeats N times, where N is a number.

4. The method of claim 3, wherein N source elements are retrieved from the source data and included in the destination data.

5. The method of claim 3, wherein the parent element is a paging element that repeats and the destination element is a child element of the paging element.

6. The method of claim 1, wherein the relative path is used when the source element is a 1:many element.

7. The method of claim 1, wherein analyzing comprises:
when the parent element is associated with a source parent element that is a parent for the source element, using the relative path.

8. The method of claim 1, wherein analyzing comprises:
when the parent element is not associated with a source parent element for the source element, using the absolute path.

9. The method of claim 1, wherein generating the document comprises:
when the relative path is used, for the source element mapped to the destination element, iteratively retrieving each instance of the source element in the source data using the relative path; and
storing each instance of the retrieved source element in the destination data in the destination format.

10. The method of claim 1, wherein generating the document comprises:
traversing the view to determine the absolute path or relative path for each source element that is mapped to each destination element;
retrieving the source element associated with the absolute path or the relative path from the source data; and
storing the retrieved source element in the destination data in the destination format.

11. A non-transitory computer-readable storage medium containing instructions, that when executed, control a computer system to be configured for:
generating a view of destination elements that are in a destination format;
detecting a mapping of a source element from source data to a destination element in the view;
analyzing a first path of the source element and a second path for a parent element to the destination element to determine whether the mapping should use an absolute path or a relative path;
when the relative path should be used, storing the relative path to map the destination element to the source element, the relative path being dependent on the second path for the parent element;
when the absolute path should be used, storing the absolute path to map the destination field to the source element, the absolute path not being dependent on the second path for the parent element; and
generating a document that maps the source element in the source format to destination data in the destination format, the source element being retrieved from the source data using the relative path or the absolute path.

12. The non-transitory computer-readable storage medium of claim 11, wherein analyzing comprises:
determining, by the computing device, when a prefix of the first path of the source element matches at least a portion of the second path of the parent element;
when the prefix matches the second path, determining the relative path should be used; and
when the prefix does not match at least a portion of the second path does not match, determining the absolute path should be used.

13. The non-transitory computer-readable storage medium of claim 11, wherein the parent element is a 1:many element indicating the parent element repeats N times, where N is a number.

14. The non-transitory computer-readable storage medium of claim 13, wherein N source elements are retrieved from the source data and included in the destination data.

15. The non-transitory computer-readable storage medium of claim 11, wherein generating the document comprises:
when the relative path is used, for the source element mapped to the destination element, iteratively retrieving each instance of the source element in the source data using the relative path; and
storing each instance of the retrieved source element in the destination data in the destination format.

16. The non-transitory computer-readable storage medium of claim 11, wherein the relative path is used when the source element is a 1:many element.

17. The non-transitory computer-readable storage medium of claim 11, wherein analyzing comprises:
when the parent element is associated with a source parent element that is a parent for the source element, using the relative path.

18. The non-transitory computer-readable storage medium of claim 11, wherein analyzing comprises:
when the parent element is not associated with a source parent element for the source element, using the absolute path.

19. The non-transitory computer-readable storage medium of claim 11, wherein generating the document comprises:
traversing the view to determine the absolute path or relative path for each source element that is mapped to each destination element;
retrieving the source element associated with the absolute path or the relative path from the source data; and
storing the retrieved source element in the destination data in the destination format.

20. An apparatus comprising:
one or more computer processors; and
a non-transitory computer-readable storage medium comprising instructions, that when executed, control the one or more computer processors to be configured for:
generating a view of destination elements that are in a destination format;
detecting a mapping of a source element from source data to a destination element in the view;
analyzing a first path of the source element and a second path for a parent element to the destination element to determine whether the mapping should use an absolute path or a relative path;
when the relative path should be used, storing the relative path to map the destination element to the source element, the relative path being dependent on the second path for the parent element;
when the absolute path should be used, storing the absolute path to map the destination field to the source element, the absolute path not being dependent on the second path for the parent element; and
generating a document that maps the source element in the source format to destination data in the destination format, the source element being retrieved from the source data using the relative path or the absolute path.
